(19) United States
(12) Patent Application Publication
(10) Pub. No.: US 2008/0079639 A1
(43) Pub. Date: Apr. 3, 2008

(54) NOISE-SUPRESSING ANTENNA ASSAMBLAGE

(75) Inventor: Yu Jen-Huan, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/672,526

(22) Filed: Feb. 8, 2007

(30) Foreign Application Priority Data
Sep. 28, 2006 (TW) 95135921

(51) Int. Cl. H01Q 1/24

(52) U.S. Cl. 343/702

(57) ABSTRACT

A noise-suppressing antenna assemblage applicable for being disposed within an electronic device is provided. The antenna assemblage includes an antenna and a blocking sheet. The blocking sheet is disposed on one side edge of the antenna in the transversal direction of the antenna, and forms a included angle with the antenna, which is 20 to 90 degrees. The blocking sheet is capable of efficiently blocking the electromagnetic wave noises coming from the electronic device to the antenna, due to the included angle.

### CROSS-REFERENCE TO RELATED APPLICATION

This application claims the priority benefit of Taiwan application serial no. 95135921, filed Sep. 28, 2006. All disclosure of the Taiwan application is incorporated herein by reference.

### BACKGROUND OF THE INVENTION

1. Field of the Invention

The present invention relates to an antenna assemblage. More particularly, the present invention relates to a noise-suppressing antenna assemblage.

2. Description of Related Art

As the rapid progress of network technology and semiconductor technology, network receiving/transmission interface has been widely used in certain electronic device, for example, notebook computers and personal digital assistants (PDAs), etc. Wireless network interface can further make the user not be limited by the conventional network wires when the electronic device is linked to the network, such that it is convenient for the user to access the Internet anywhere. Therefore, the wireless network technology has become a hot trend in recent years.

Although it is convenient to use the wireless network, since the wireless network transfers signals via radio waves, the antenna used to receive the signals may be affected by noises coming from the surrounding environment and from the electronic device during the data receiving or data transmission process. Taking the notebook computer for example, the antenna of the notebook computer is usually mounted on an external frame structure of the liquid crystal display. The driver of the liquid crystal display may generate a video clock, and certain frequency composition of the video clock overlaps the frequency of the antenna, so that the interference occurs.

In order to eliminate the above defect, Taiwan Utility Model Patent Publication No. M286399 discloses a shielding apparatus, in which a shielding plate can be used to shield the antenna, so as to block noises coming from the driver of the liquid crystal display to the antenna.

FIG. 1 is a schematic diagram of a conventional shielding apparatus applied to a notebook computer having an antenna. Referring to FIG. 1, the shielding apparatus 100 is disposed within a first case 52 of the notebook computer 50, and located under the antenna 56, which is used for blocking noises coming from a first electromagnetic wave source 52a located within the first case 52 to the antenna 56. The shielding apparatus 100 includes a shielding plate 110 having a first surface 110a parallel to the antenna 56 and a second surface 110b vertical to the antenna 56. The shielding plate 110 is made of a conductive material, so as to effectively block the electromagnetic waves, thereby preventing the antenna 56 from being interfered by the noises coming from the first electromagnetic wave source 52a.

However, in the shielding apparatus 100, the part of the shielding plate 110 mainly used to provide the shielding function is vertical to the second surface 110b of the antenna 56, such that it can merely block the electromagnetic waves coming from the first electromagnetic wave source 52a (i.e., the driver of the liquid crystal display) to the antenna 56, but cannot effectively block the electromagnetic waves coming from the second electromagnetic wave source 54a (for example, the clock generation circuit of the notebook computer) in a second case 54 of the notebook computer to the antenna 56.

### SUMMARY OF THE INVENTION

Accordingly, the present invention is directed to an antenna assemblage, which is capable of effectively blocking noises coming from an electronic device.

As embodied and broadly described herein, the present invention provides an antenna assemblage, applicable for being disposed within an electronic device. The antenna assemblage comprises an antenna and a blocking sheet. The blocking sheet is located on a side edge of the antenna in a transversal direction, and forms a first included angle with the antenna, which is 20 to 90 degrees.

In an embodiment of the present invention, the transversal direction of the blocking sheet and the transversal direction of the antenna from the first included angle.

In an embodiment of the present invention, the blocking sheet has a projection on a surface of the antenna in a normal direction of the surface.

In an embodiment of the present invention, the blocking sheet is coupled to a ground terminal of the electronic device.

In an embodiment of the present invention, the material of the blocking sheet comprises copper or aluminum.

In an embodiment of the present invention, the antenna is fixed to an inner surface of a case of the electronic device.

As embodied and broadly described herein, the present invention provides an antenna assemblage, applicable for being disposed within an electronic device. The antenna assemblage comprises an antenna and a blocking sheet. The blocking sheet is located on a side edge of the antenna in the transversal direction of the antenna, and has a first part and a second part. The first part and the antenna form a first included angle that is 20 to 170 degrees, and the second part and the first part form a second included angle that is 20 to 170 degrees.

In an embodiment of the present invention, the transversal direction of the first part and the transversal direction of the antenna form the first included angle.

In an embodiment of the present invention, the transversal direction of the second part and the transversal direction of the first part form the second included angle.

In an embodiment of the present invention, the first part of the blocking sheet has a projection on a first surface of the antenna in a normal direction of the first surface.

In an embodiment of the present invention, the second part of the blocking sheet has a projection on a surface of the antenna in a normal direction of the surface.

In an embodiment of the present invention, the first part and the second part of the blocking sheet are integrally formed.

In an embodiment of the present invention, the blocking sheet further has a third part, the third part and the first part are respectively located on two sides of the antenna, and the third part and the antenna form a third included angle that is 20 to 90 degrees.

In an embodiment of the present invention, the transversal direction of the third part and the transversal direction of the antenna form the third included angle.

In an embodiment of the present invention, the third part has a projection on a second surface of the antenna in a normal direction of the second surface.

In an embodiment of the present invention, the first part, the second part, and the third part of the blocking sheet are integrally formed.

In an embodiment of the present invention, the blocking sheet further has a third part and a fourth part, the third part and the fourth part and the first part are respectively located on two sides of the antenna, the third part and the antenna form a third included angle that is 20 to 170 degrees, and the fourth part and the third part form a fourth included angle that is 20 to 170 degrees.

In an embodiment of the present invention, the transversal direction of the third part and the transversal direction of the antenna form the third included angle.

In an embodiment of the present invention, the transversal direction of the fourth part and the transversal direction of the third part form the fourth included angle.

In an embodiment of the present invention, the third part of the blocking sheet has a projection on a second surface of the antenna in a normal direction of the second surface.

In an embodiment of the present invention, the fourth part of the blocking sheet has a projection on a second surface of the antenna in a normal direction of the second surface.

In an embodiment of the present invention, the first part, the second part, the third part, and the fourth part of the blocking sheet are integrally formed.

In an embodiment of the present invention, the blocking sheet is coupled to a ground terminal of the electronic device.

In an embodiment of the present invention, the material of the blocking sheet comprises copper or aluminum.

In an embodiment of the present invention, the antenna is fixed to an inner surface of a case of the electronic device.

In the antenna assemblage of the present invention, the blocking sheet has a projection on the surface of the antenna in the normal direction of the surface of the antenna, thus it can more effectively block the noises coming from the electronic device to the antenna.

In order to make the aforementioned and other objectives, features, and advantages of the present invention be more comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional shielding apparatus applied to a notebook computer having an antenna.

FIG. 2A is a front view of an antenna assemblage according to a first embodiment of the present invention.

FIG. 2B is a side view of the antenna assemblage of FIG. 2A.

FIG. 3 is a schematic diagram of the antenna assemblage of FIG. 2 applied to an electronic device.

FIG. 4 is a side view of the antenna assemblage according to a second embodiment of the present invention.

FIG. 5 is a side view of the antenna assemblage according to a third embodiment of the present invention.

FIG. 6 is a side view of the antenna assemblage according to a fourth embodiment of the present invention.

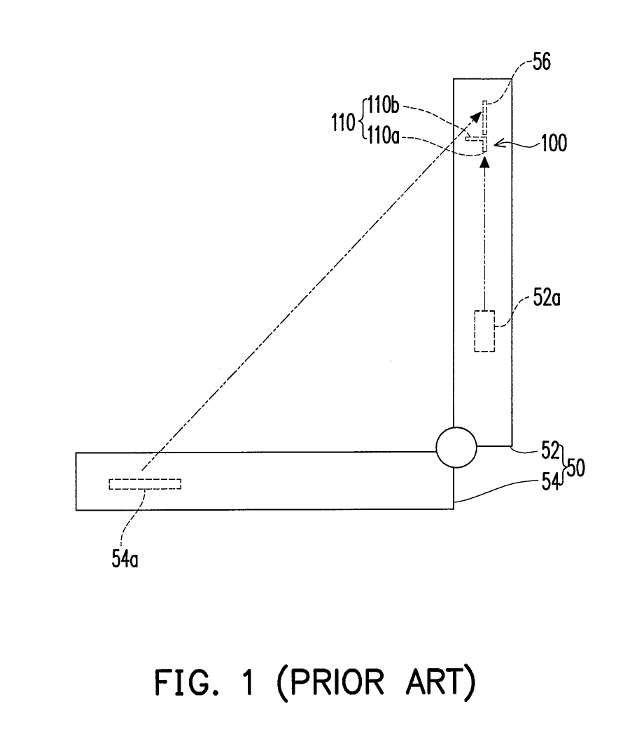

### DESCRIPTION OF EMBODIMENTS

### The First Embodiment

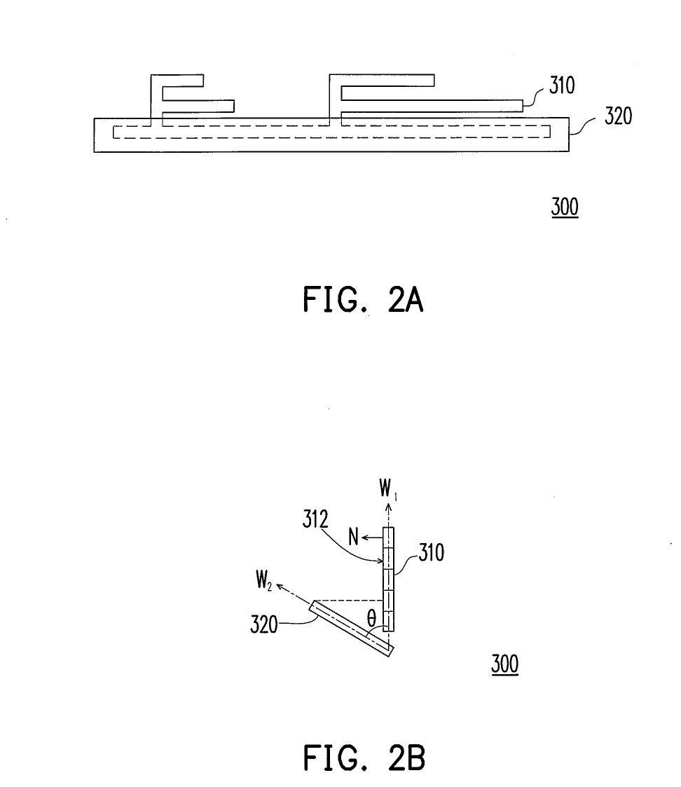

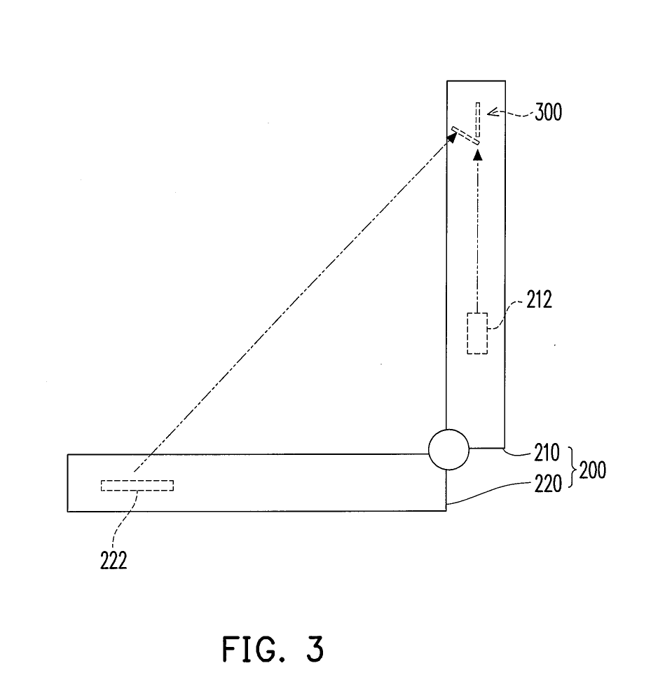

FIG. 2A is a front view of an antenna assemblage according to a first embodiment of the present invention, FIG. 2B is a side view of the antenna assemblage of FIG. 2A, and FIG. 3 is a schematic diagram of the antenna assemblage of FIG. 2A applied to an electronic device. Referring to FIGS. 2A, 2B, and 3, the antenna assemblage 300 of the first embodiment is applicable for being disposed in an electronic device 200. In the first embodiment, the antenna 310 is, for example, a dual frequency antenna, and the electronic device 200 is, for example, a notebook computer, but which are not limited herein. The electronic device 200 includes a first case 210 and a second case 220. The first case 210 has a first electromagnetic wave source 212, for example, a driver of a liquid crystal display. The second case 220 has a second electromagnetic wave source 222, for example, a clock generation circuit of the electronic device 200.

The antenna assemblage 300 includes an antenna 310 and a blocking sheet 320. The blocking sheet 320 is located on a side edge of the antenna 310 in a transversal direction W₁, and forms a first included angle θ₁ with the antenna 310, which is 20 to 90 degrees.

In the first embodiment, the first included angle θ₁ may be the included angle between the transversal direction W₂ of the blocking sheet 320 and the transversal direction W₁ of the antenna 310, and the blocking sheet 320 has a projection on a surface 312 of the antenna 310 in a normal direction N of the surface 312. That is to say, as seen in the normal direction N, the blocking sheet 320 shields a part of the antenna 310, and thus not only the electromagnetic waves coming from the first electromagnetic wave source 212 located in the transversal direction W₁ of the antenna 310 to the antenna 310 are blocked, but the electromagnetic waves coming from the second electromagnetic wave source 222 located out of the transversal direction W₁ of the antenna 310 to the antenna 310 are also blocked.

The blocking sheet 320 is made of a conductive material, for example, copper or aluminum, and the blocking sheet 320 is coupled to a ground terminal of the electronic device 200. Furthermore, as shown in FIG. 3, the antenna 310 can be fixed to an inner surface of the first case 210 of the electronic device 200.

### The Second Embodiment

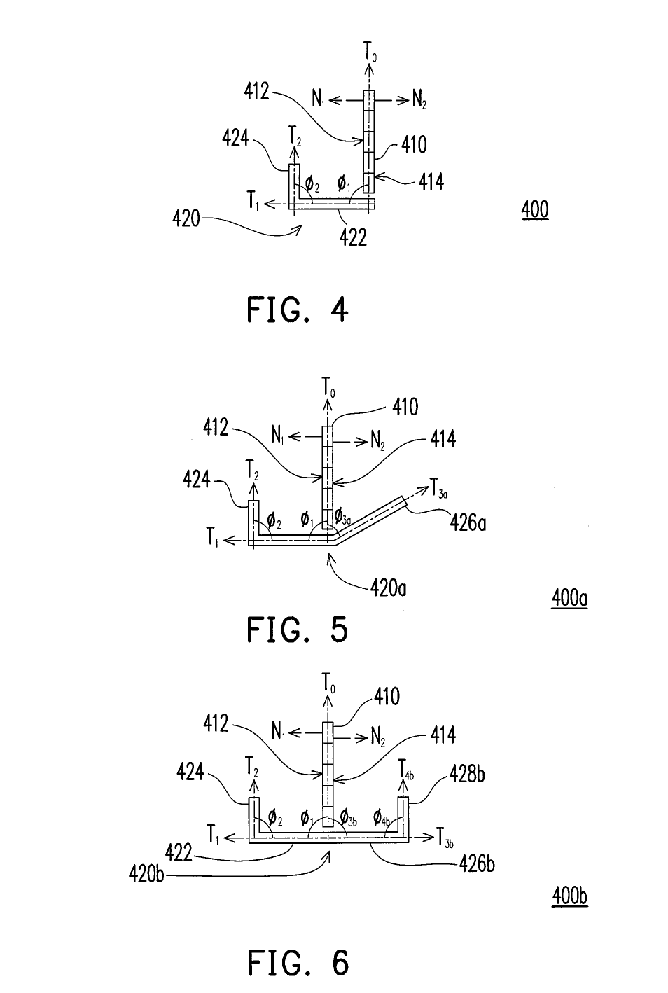

In order to enhance the shielding effect of the antenna assemblage, the blocking sheet may have a plurality of parts that is not parallel to each other. FIG. 4 is a side view of the antenna assemblage according to a second embodiment of the present invention. Referring to FIG. 4, the antenna assemblage 400 of the second embodiment is applicable for being disposed within the electronic device 200 of FIG. 3, and includes an antenna 410 and a blocking sheet 420. The blocking sheet 420 is located on a side edge of the antenna 410 in the transversal direction T₀.

The blocking sheet 420 has a first part 422 and a second part 424. The first part 422 of the blocking sheet 420 and the antenna 410 form a first included angle φ₁ being 20 to 170 degrees, and the second part 424 and the first part 422 form a second included angle φ₂ being 20 to 170 degrees. The antenna 410 has a first surface 412 and a second surface 414.

In the second embodiment, the transversal direction T₁ of the first part 422 and the transversal direction T₀ of the antenna 410 form the first included angle φ₁ and the transversal direction T₂ of the second part 424 and the transversal direction T₁ of the first part 422 form the second included angle φ₂.

In view of the above, the first part 422 of the blocking sheet 420 has a projection on the first surface 412 of the antenna 410 in the normal direction N₁ of the first surface 412, and the second part 424 of the blocking sheet 420 also has a projection on the first surface 412 of the antenna 410 in the normal direction N₁ of the first surface 412. The additional second part 424 can further enhance the blocking effect of the blocking sheet 420 to the electromagnetic waves sent from the second electromagnetic wave source 222 to the antenna 410.

The blocking sheet 420 is made of a conductive material, for example, copper or aluminum, and the blocking sheet 420 is coupled to a ground terminal of the electronic device 200 shown in FIG. 3. Furthermore, as the antenna 310 in the first embodiment, the antenna 410 can be fixed to the inner surface of the first case 210 of the electronic device 200 shown in FIG. 3. Furthermore, the first part 422 and the second part 424 of the blocking sheet 420 can be integrally formed, but those skilled in the art can select other manners for implementation, for example, the first part 422 and the second part 424 are fabricated separately, and then they are jointed together.

### The Third Embodiment

FIG. 5 is a side view of the antenna assemblage according to a third embodiment of the present invention. In the third embodiment and the second embodiment, the same or similar reference numerals represent the same or similar elements, and the third embodiment is substantially the same as the second embodiment. The differences between the two embodiments are described below in detail, and the same parts there-between are omitted.

Referring to FIG. 5, in the antenna assemblage 400a of the third embodiment, the blocking sheet 420a further has a third part 426a. The third part 426a and the first part 422 are respectively located on two sides of the antenna 410, and the third part 426a and the antenna 410 form a third included angle φ₃ₐ being 20 to 90 degrees. The third part 426a has a projection on the second surface 414 of the antenna 410 in the normal direction N₂ of the second surface 414. The third included angle φ₃ₐ is the included angle formed by the transversal direction T₃ₐ of the third part 426a and the transversal direction T₀ of the antenna 410. The first part 422, the second part 424, and the third part 426a of the blocking sheet 420a can be integrally formed.

The third part 426a of the blocking sheet 420a extends to the second surface 414 of the antenna 410, such that the blocking sheet 420a can block the electromagnetic wave interference that is not generated by the electronic device 200 itself shown in FIG. 3, for example, other peripheral electrical appliances, which further maintains the signal receiving quality of the antenna 410.

### The Fourth Embodiment

FIG. 6 is a side view of the antenna assemblage according to a fourth embodiment of the present invention. In the fourth embodiment and the second embodiment, the same or similar reference numerals represent the same or similar elements, and the fourth embodiment is substantially the same as the second embodiment. The differences between the two embodiments are described below in detail, and the same parts there-between are omitted.

Referring to FIG. 6, in the antenna assemblage 400b of the fourth embodiment, the blocking sheet 420b further has a third part 426b and a fourth part 428b. The third part 426b and the fourth part 428b and the first part 422 are respectively located at two sides of the antenna 410, and the third part 426b and the antenna 410 form a third included angle φ_{3b} being 20 degrees to 170 degrees, and the fourth part 428b and the third part 426b form a fourth included angle φ_{4b} being 20 to 170 degrees.

In the fourth embodiment, the transversal direction T_{3b} of the third part 426b and the transversal direction T₀ of the antenna 410 form the third included angle φ_{3b}, and the transversal direction T_{4b} of the fourth part 428b and the transversal direction T_{3b} of the third part 426b form the fourth included angle φ_{4b}. Furthermore, the third part 426b has a projection on the second surface 414 of the antenna 410 in the normal direction N₂ of the second surface 414, and the fourth part 428b has a projection on the second surface 414 of the antenna 410 in the normal direction N₂ of the second surface 414. Furthermore, the first part 422, the second part 424, the third part 426b, and the fourth part 428b of the blocking sheet 420b can be integrally formed.

The additional fourth part 428b of the blocking sheet 420b can further enable the blocking sheet 420b to block the electromagnetic wave interference generated by other electromagnetic wave sources except the electronic device 200 of FIG. 3, which further maintains the receiving sensitivity of the antenna 410.

To sum up, the present invention at least has the following advantages.

1. In the antenna assemblage of the present invention, the blocking sheet has a projection on a surface of the antenna in the normal direction of the surface, thereby effectively blocking the electromagnetic wave interference generated by the electronic device.

2. The blocking sheet has projections on both sides of the antenna, such that the blocking sheet can block the electromagnetic wave interference generated by the electronic device, and can also block the electromagnetic wave noises generated by the surrounding environment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An antenna assemblage, applicable for being disposed in an electronic device, comprising:
an antenna; and
a blocking sheet, located on a side edge of the antenna in a transversal direction and forming a first included angle that is 20 to 90 degrees with the antenna.

2. The antenna assemblage as claimed in claim 1, wherein the transversal direction of the blocking sheet and the transversal direction of the antenna form the first included angle.

3. The antenna assemblage as claimed in claim 1, wherein the blocking sheet has a projection on a surface of the antenna in a normal direction of the surface.

4. The antenna assemblage as claimed in claim 1, wherein the blocking sheet is coupled to a ground terminal of the electronic device.

5. The antenna assemblage as claimed in claim 1, wherein the material of the blocking sheet comprises copper or aluminum.

6. The antenna assemblage as claimed in claim 1, wherein the antenna is fixed to an inner surface of a case of the electronic device.

7. An antenna assemblage, applicable for being disposed within an electronic device, comprising:
an antenna; and
a blocking sheet, located on a side edge of the antenna in the transversal direction, and having a first part and a second part, wherein the first part and the antenna form a first included angle being 20 to 170 degrees, and the second part and the first part form a second included angle being 20 to 170 degrees.

8. The antenna assemblage as claimed in claim 7, wherein the transversal direction of the first part and the transversal direction of the antenna form the first included angle.

9. The antenna assemblage as claimed in claim 7, wherein the transversal direction of the second part and the transversal direction of the first part form the second included angle.

10. The antenna assemblage as claimed in claim 7, wherein the first part of the blocking sheet has a projection on a first surface of the antenna in a normal direction of the first surface.

11. The antenna assemblage as claimed in claim 7, wherein the second part of the blocking sheet has a projection on a first surface of the antenna in a normal direction of the first surface.

12. The antenna assemblage as claimed in claim 7, wherein the first part and the second part of the blocking sheet are integrally formed.

13. The antenna assemblage as claimed in claim 7, wherein the blocking sheet further has a third part, the third part and the first part are respectively located on two sides of the antenna, and the third part and the antenna form a third included angle being 20 to 90 degrees.

14. The antenna assemblage as claimed in claim 13, wherein the transversal direction of the third part and the transversal direction of the antenna form the third included angle.

15. The antenna assemblage as claimed in claim 13, wherein the third part has a projection on a second surface of the antenna in a normal direction of the second surface.

16. The antenna assemblage as claimed in claim 13, wherein the first part, the second part, and the third part of the blocking sheet are integrally formed.

17. The antenna assemblage as claimed in claim 7, wherein the blocking sheet further has a third part and a fourth part, the third part and the fourth part and the first part are respectively located on two sides of the antenna, the third part and the antenna form a third included angle being 20 to 170 degrees, and the fourth part and the third part form a fourth included angle being 20 to 170 degrees.

18. The antenna assemblage as claimed in claim 17, wherein the transversal direction of the third part and the transversal direction of the antenna form the third included angle.

19. The antenna assemblage as claimed in claim 17, wherein the transversal direction of the fourth part and the transversal direction of the third part form the fourth included angle.

20. The antenna assemblage as claimed in claim 17, wherein the third part of the blocking sheet has a projection on a second surface of the antenna in a normal direction of the second surface.

21. The antenna assemblage as claimed in claim 17, wherein the fourth part of the blocking sheet has a projection on a second surface of the antenna in a normal direction of the second surface.

22. The antenna assemblage as claimed in claim 17, wherein the first part, the second part, the third part, and the fourth part of the blocking sheet are integrally formed.

23. The antenna assemblage as claimed in claim 7, wherein the blocking sheet is coupled to a ground terminal of the electronic device.

24. The antenna assemblage as claimed in claim 7, wherein the material of the blocking sheet comprises copper or aluminum.

25. The antenna assemblage as claimed in claim 7, wherein the antenna is fixed to an inner surface of a case of the electronic device.
